(19) United States
(12) Patent Application Publication
(10) Pub. No.: US 2024/0246087 A1
(43) Pub. Date: Jul. 25, 2024

(54) COUPLING FOR A GRINDING MILL LINER

(71) Applicant: Bradken Resources Pty Limited, New South Wales (AU)

(72) Inventors: Michael Stewart GRAY, New South Wales (AU); Craig Frank FAULKNER, Capalaba (AU)

(73) Assignee: Bradken Resources Pty Limited, New South Wales (AU)

(21) Appl. No.: 18/290,397

(22) PCT Filed: May 11, 2022
(86) PCT No.: PCT/AU2022/050448

§ 371 Date: Nov. 13, 2023

(30) Foreign Application Priority Data
May 11, 2021 (AU) 2021901397
Aug. 24, 2021 (AU) 2021221552

(51) Int. Cl. B02C 17/22; F16B 5/02; F16B 5/10; F16B 23/00; F16B 33/00; F16B 35/06; F16B 43/00

(52) U.S. Cl. CPC B02C 17/22; F16B 5/02; F16B 5/10; F16B 23/0007; F16B 23/0069; F16B 33/002; F16B 35/06; F16B 43/001

(57) ABSTRACT

Disclosed is a mill liner assembly for a grinding mill. The mill liner assembly including a mill liner and a head nut for the mill liner. The liner comprises a wear surface and an opposite inner surface. The head nut forming part of a coupling for use in removably mounting the mill liner to an interior surface of the grinding mill. The mill liner assembly further comprises at least one passage having an interior wall extending through in the liner for receiving the head nut. The head nut includes a leading end and a trailing end being spaced apart along an axis. The head nut also comprises a body having an interior bore extending along the axis operative to receive a shank, the shank forming part of the coupling, and an engaging portion connected to or integrally formed with the body to engage the interior wall of the passage to retain the head nut in the at least one passage in the mill liner. Also disclosed is a method of installation of a head nut in a mill liner.

### CROSS-REFERENCE TO RELATED APPLICATIONS

This application is a national stage application under 35 USC 371 of International Application No. PCT/AU2022/050448, filed May 11, 2022, which claims the priority of Australian Application No. 2021901397, filed May 11, 2021, and Australian Application No. 2021221552, filed Aug. 24, 2021. The entire contents of each priority application is incorporated herein by reference.

### FIELD OF THE DISCLOSURE

The present disclosure relates to a mill liner for a grinding mill, a head nut for a mill liner coupling of a grinding mill, and a method of installation of a head nut within a passage of a mill liner.

### BACKGROUND OF THE DISCLOSURE

Grinding mill liners for semi-autogenous mills (SAG), autogenous mills (AG), rod, and ball mills are replaceable wear parts that extend the life of the mill. Grinding mill liners are fastened to a cylindrical interior surface of the grinding mill. In order to install or remove the mill liners from the grinding mill, an operator is required inside the mill which is a harsh and hazardous environment. Due to the shape of the grinding mills, the operators are often required to climb inside of the mill to remove or install liners. Further, slings or chains may be used to assist with the installation and removal process but require the operators to be inside the grinding mill to attach and release the slings or chains to the mill liners.

It is to be understood that, if any prior art is referred to herein, such reference does not constitute an admission that the prior art forms a part of the common general knowledge in the art, in Australia or any other country.

### SUMMARY OF THE DISCLOSURE

According to a first aspect, disclosed is a mill liner assembly for a grinding mill. The assembly includes a mill liner comprises a wear surface and an opposite inner surface, and a head nut forming part of a coupling for use in removably mounting the liner to an interior surface of the grinding mill. The mill liner further comprises at least one passage having an interior wall extending for receiving the head nut. The head nut has a leading end and a trailing end spaced along an axis and comprises a body having an interior bore extending along an axis operative to receive a shank, the shank forming part of the coupling. The head nut further comprises an engaging portion connected to or integrally formed with the body to engage the interior wall of the passage to retain the head nut in the at least one passage in the mill liner.

Having an arrangement where the head nut is separate from the coupling shaft and able to be retained in the liner passage, allows liner installation and removal to occur outside the grinding mill, which provides a safe and efficient solution to liner installation and removal. The head nut may be preinstalled in the mill liner which allows for the operator to remain outside the mill and secure the coupling from outside the mill.

Having the engaging portion connected to or integrally formed with the body further simplifies the installation process as the head nut can be installed and retained in a single operation. It also allows the head nut to be more precisely retained in the passage to facilitate the connection of the shank to the head nut. This may be through more accurate axial and/or angular positioning of the head nut in the passage.

In some forms, the retention of the head nut in the passage by the engaging portion is for the purposes of transport and/or positioning for installation. In this arrangement, the head nut may separately engage with a surface of the liner when connected with the shank to provide the required reaction force to allows those components to act as a coupling to secure the mill liner to grinding mill shell. In this arrangement, the engaging portion provides temporary retention and the head nut may move subsequently (for example by tensioning of the coupling) to its final operational position.

In some forms, the engaging portion may also form part of the operational connection of the coupling to the mill liner and as such contribute at least in part to provide the required reaction force of the coupling.

In some forms, the engaging portion may be connected to the body through vulcanization, adhesion, or welding. In some forms, the engaging portion may be integrally formed with the body through moulding or extrusion.

In some forms, the engaging portion is formed of a deformable material which retains the head nut within the least one passage. The engaging portion being formed of a deformable material allows for the engaging portion to engage the interior wall of the passage by frictional engagement. It is understood that the deformable material could be resilient and deform elastically or undergo plastic deformation when inserted. It may be formed of an elastomeric material like rubber or a flexible material like neoprene.

In alternative embodiments, a different type of engagement between the engaging portion and the interior wall of the passage may be employed, such as mechanical engagement where the head nut has components that are captured in the passage, by following a helical path defined by the passage, a snap fit or twist arrangement, or otherwise by a locking arrangement.

In alternative embodiments, the engaging portion may also be a combination of a deformable material and a non-deformable material.

The engaging portion when formed as a deformable component may provide sufficient frictional resistance to allow engagement of the coupling from outside the mill while retaining the head nut in position in the mill liner. Alternatively, the engaging portion may be engaged by a combination of deformable component and a mechanical engagement.

The interior wall of the passage in the liner may formed from the liner itself or may be formed by a sleeve that is inserted into mill liner. In this latter arrangement, the head nut may be inserted into the sleeve and then the combination of the head nut and sleeve located in the liner. Alternatively, the sleeve may be preinstalled in liner before the head nut is inserted.

In some forms, the engaging portion may extend from the head nut body to the trailing end (when the head nut is formed from only two components), or may extend along a portion thereof where the head nut includes other components, such as an intermediate member between the engaging portion and the body, an outer cover portion, or both.

In such an arrangement, the engaging portion may have a secondary function to provide a protective layer to the head nut or provide at least part of a sealing arrangement that prevents fines from entering the passage. In other forms, the engaging portion may provide an indication of wear of the mill liner.

In some forms, the passage extends through the liner from the wear surface to the inner surface and the heat nut is located in the passage via the wear surface. The engaging portion may form an extension to the head nut body and be arranged to at least substantially “fill” the passage. Such an arrangement is particularly suited when the engaging portion is formed at least in part from a deformable material. In other arrangements, the head nut does not fill then passage and in such an arrangement a separate cover or plug may be applied to the hole to passage.

In some forms, the interior wall of the at least one passage is a substantially mating shape to the external surface of the head nut. There may be a clearance between the external surface of the head nut and the interior wall of the passage in at least some regions. Further, the mating connection of the head nut and the passage are not required to be identically complementing shapes providing they are able to be assembled. In some forms, the cross-sectional shape (in the radial plane) of the head nut is generally hexagonal. It is understood that the cross-sectional shape in the radial plane may be any non-circular shape such as rectangular. The cross-sectional shape may vary in the direction of the axis. For example, the cross-sectional shape in the radial plane may taper towards the leading end.

In some forms, the body may include a shaped surface forming the leading end of the head nut allowing the head nut to move relative to an opposed seat formed as part of the interior wall of the at least one passage to self-centre and align the interior bore of the body relative to an opening of the passage for receipt of the shank in use.

In some forms, the engaging portion maintains the alignment of the bore of the head nut relative to the at least one passage for locating the shank therein. The head nut is operative to be a guide in that the engaging portion aligns the leading end of the head nut into a seated position where the leading end abuts the seat formed in the interior wall of the passage, and the interior bore is aligned with an opening of the passage for receipt of the shank via the exterior of the mill.

In some forms, the engaging portion extends in a radial direction defining a shoulder which extends about the external surface of the head nut, and, wherein in use, the shoulder is arranged to engage a corresponding shoulder defined in the interior wall of the passage.

In some forms, the engaging portion includes external profiling formed on its external surface protruding in the radial direction from the external surface of the body. The external profiling may include ribs, fins, an engaging structure(s), and/or tabs. The external profiling may increase the frictional engagement of the engaging portion against the interior wall of the passage increasing the external surface irregularity. The external profiling may also enable mechanical engagement of the engaging portion in relation to the interior wall of the passage.

In some forms, the external profiling includes one or more ribs extending in the direction of the axis of the at least one passage.

In some forms, the external profiling includes one or more fins extending as a radial band about the external surface. In some embodiments, the one or more fins may be spaced apart or interrupted and are not required to continuously extend.

In some forms, when the head nut is located in the at least one passage, the trailing end is substantially flush with the wear surface of the liner. In some forms, a cap may be located in the passage at the trailing end of the head nut, and the cap is flush with the wear surface of the liner. In some embodiments, a further engaging portion or cover may be connected to or integrally formed with the head nut. In some forms, the head nut may be proud of the wear surface. The head nut may be beneficial to prevent fines from residing in the passage, which can increase the wear of the liner and the coupling.

In some forms, the head nut further comprises a wear resistant portion being connected to or integrally formed with the engaging portion and the body.

According to a second aspect, disclosed is a mill liner assembly for a grinding mill, the assembly comprising a mill liner comprising a wear surface and an opposite inner surface, and a head nut forming part of a coupling for use in removably mounting the mill liner to an interior surface of the grinding mill, and the mill liner further comprises at least one passage having an interior wall extending through in the liner for receiving the head nut, wherein the head nut comprises a body having an interior bore extending along an axis operative to receive a shank, the shank forming part of the coupling: and an engaging portion connected to or integrally formed with the body to engage the interior wall of the passage to maintain the alignment the bore of the head nut relative to the at least one passage for locating the shank therein.

In some forms, the features discussed above in relation to the first aspect are also disclosed in relation to the second aspect.

According to a third aspect, disclosed is a head nut for a mill liner. The head nut forming part of a coupling for use in removably mounting the mill liner to an interior surface of the grinding mill. The mill liner including at least one passage having an interior wall extending through the liner for receiving the head nut. The head nut further comprising a body comprising an external surface, the body having an interior bore extending through the body along an axis operative to receive a shank, the shank forming part of the coupling, and an engaging portion connected to or integrally formed with the body to engage the interior wall of the passage.

In some forms, the engaging portion may be connected to the body through vulcanization, adhesion, or welding. In some forms, the engaging portion may be integrally formed with the body through moulding or extrusion. The connection method or integrally forming method may depend on the materials provided for the engaging portion and the body. In some forms the engaging portion and body may be connected directly. In other forms, they may be indirectly connected by an intermediate member.

In some forms, the engaging portion is formed of a deformable material which in use, deforms on engagement with the interior wall of the liner passage to retain the head nut within the at least one passage.

In some forms, the engaging portion extends in the radial direction defining a shoulder which extends about the external surface of the engaging portion. In some forms, the shoulder is arranged to engage a corresponding shoulder defined in the interior wall of the passage.

In some forms, the engaging portion includes external profiling formed on its external surface protruding in the radial direction from the external surface of the body.

In some forms, the external profiling includes one or more ribs extending in the direction of the axis and formed on its external surface protruding in the radial direction. In some forms, the one or more ribs are spaced apart about the external surface of the engaging portion.

In some forms, the external profiling includes one or more fins extending in the radial direction about the external surface of the engaging portion. In some forms, the one or more fins are coaxial and spaced apart.

In some forms, the engaging portion guides the head nut into a locating position for engagement with the shank by engagement with the interior wall of the at least one passage.

In some forms, the body includes a seating surface forming a leading end of the head nut allowing the head nut to move relative to an opposing seat formed on the interior wall of the at least one passage to self-centre and align the interior bore of the body relative to an opening of the passage for receipt of the shank in use. The engaging portion may maintain the axial centre line of the interior bore of the head nut in the same line as the passage to receive the shank.

In some forms, the head nut further comprises a locking arrangement including at least one locking member movable between a locked and an unlocked position, wherein, when in the locked position, the at least one locking member protrudes in the radial direction from the external surface of the head nut to engage an abutment surface formed in the interior wall of the passage to prevent removal of the head nut from the mill liner, and when in the unlocked position, the at least one locking member is moveable to locate within the head nut to allow removal of the head nut from the mill liner.

In some forms, the at least one locking member is rotatable between the locked and unlocked positions, and the engaging portion includes at least one slot extending in the radial direction to the external surface for accommodating the at least one locking member.

In some forms, the locking arrangement includes an actuator extending along the axis located within the engaging portion, the locking member extends radially from the actuator, and the actuator is rotatable about the axis to move the locking member between the locked and unlocked positions. In some forms, the actuator extends between a drive end and a support end, and the drive end is configured to receive a tool to install the head nut in the passage and/or to facilitate moving the locking arrangement between the unlocked and the locked positions. The drive end may be positioned proximal the trailing end. In some forms, the actuator may include an internal drive for operating the locking arrangement via the interior bore.

In some forms, the head nut further comprises an engagement structure radially protruding from the external surface of the head nut to engage an abutment surface defined by the interior wall of the passage to retain the head nut in position within the passage of the mill liner. In some forms, the engagement structure is embedded within the engaging portion and protrudes from the engaging portion. The engagement structure may be a spring clip that is configured to resiliently deform to locate the head nut into the seated position, and is biased to return to its original position once the head nut is in the seated position.

In some forms, the external profiling further comprises one or more elongate tab extending in the axial direction on the external surface to retain the head nut within the passage of the mill liner. In some forms, the elongate tab is configured to resiliently deform to locate the head nut into the seated position, and biased to return to its original position once the head nut is in the seated position.

In some forms, the head nut further comprises a wear resistant portion being connected to or integrally formed with the engaging portion and the body.

In some forms, the head nut includes features that are otherwise described with reference to the first and second aspect described above.

According to a fourth aspect, disclosed is a method of installation of a head nut within a passage of a mill liner, the passage being defined by an interior wall and extending to an opening in the mill liner, the head nut forming part of a coupling for use in removably mounting the liner to an interior surface of a grinding mill. The method comprising:
providing a head nut comprising a body having an interior bore extending along an axis operative to receive a shank, the shank forming part of the coupling;
locating a leading end of the body in the passage such that the body is held in a locating position such that the leading end is spaced apart from the opening of the passage: and
applying force to the head nut to move the head nut to a seated position where the leading end abuts the interior wall of the passage, and the interior bore is aligned with the opening of the passage.

In some forms, the head nut comprises an engaging portion connected to or integrally formed with the body and the engaging portion engages the interior wall un the locating position.

In some forms, a force is applied to the trailing end of the head nut to move the head nut to the seated position.

In some forms, a force is applied to the body to move the head nut to the seated position.

According to a fifth aspect, disclosed is a method of shipping, storage, installation and/or use of a mill liner for a grinding mill, the method comprising:
providing a mill liner for a grinding mill, the mill liner including at least one passage being defined by an interior wall; and
providing a head nut comprising a body having an interior bore extending along an axis operative to receive a shank, the shank forming part of a coupling, and an engaging portion connected to or integrally formed with the body;
locating the head nut to a seated position where the engaging portion engages the interior wall of the passage so as to retain the head nut with the miller liner for shipping, storage, installation and/or use of the mill liner.

In some forms, the head nut resists axial movement in both directions (i.e., inward and outward of the passage) to better resist unintentional loss of the head nut during shipping, storage, installation and use. In some forms, the head nut is frictionally retained in the passage of the mill liner. In some forms, the head nut is mechanically retained in the passage of the mill liner. In some forms, the head nut is retained in the passage of the mill liner through both frictional and mechanical engagement.

According to a sixth aspect, disclosed is a mill liner assembly including a mill liner and one or more couplings, wherein the coupling includes the head nut as defined in the third aspect and a shank. The coupling may also include a further nut being arranged to be secured to an opposite end of the shank. Further components may be provided to the coupling such as one or more washers, (for example a sealing washer and/or recessed washer).

According to a seventh aspect, disclosed is a mill liner for use in the miller liner assembly of the first and second aspects and/or the methods as disclosed in the fourth fifth or sixth aspect disclosed above.

### BRIEF DESCRIPTION OF THE FIGURES

Embodiments will now be described by way of example only, with reference to the accompanying drawings in which

FIG. 1 is an exploded perspective view of an embodiment of a coupling, a mill liner and a section of a grinding mill wall:

FIG. 2a is a side perspective view of a first embodiment of a head nut which may form part of the coupling of FIG. 1:

FIG. 2b is a leading end perspective view of the head nut of FIG. 2a:

FIG. 2c is a trailing end view of the head nut of FIG. 2a:

FIG. 2d is a cross-sectional view of the head nut of FIG. 2c along the line D-D;

FIG. 2e is a side view of the head nut of FIG. 2a;

FIG. 3a is a side perspective view of a second embodiment of a head nut which may form part of the coupling of FIG. 1;

FIG. 3b is a leading end perspective view of the head nut of FIG. 3a;

FIG. 3c is a trailing end view of the head nut of FIG. 3a;

FIG. 3d is a cross-sectional view of the head nut of FIG. 3c along the line F-F;

FIG. 3e is a side view of the head nut of FIG. 3a;

FIG. 4a is a side perspective view of an embodiment of a head nut in an unlocked position which may form part of the coupling of FIG. 1;

FIG. 4b is a leading end perspective view of the head nut of FIG. 4a;

FIG. 4c is a trailing end view of the head nut of FIG. 4a;

FIG. 4d is a cross-sectional view of the head nut of FIG. 4c along the line D-D;

FIG. 4e is a side view of the head nut of FIG. 4a;

FIG. 5a is a side perspective view of an embodiment of the head nut in a locked position of FIG. 4a;

FIG. 5b is a leading end perspective view of the head nut of FIG. 5a;

FIG. 5c is a trailing end view of the head nut of FIG. 5a;

FIG. 5d is a side view of the head nut of FIG. 5a;

FIG. 5e is a cross-sectional view of the head nut of FIG. 5c along the line G-G;

FIG. 6a is a side perspective view of an embodiment of a head nut which may form part of the coupling of FIG. 1:

FIG. 6b is a leading end perspective view of the head nut of FIG. 6a:

FIG. 6c is a trailing end view of the head nut of FIG. 6a;

FIG. 6d is a cross-sectional view of the head nut of FIG. 6c along the line A-A:

FIG. 6e is a side view of the head nut of FIG. 6a:

FIG. 7a is a side perspective view of an embodiment of a head nut which may form part of the coupling of FIG. 1;

FIG. 7b is a leading end perspective view of the head nut of FIG. 7a:

FIG. 7c is a trailing end view of the head nut of FIG. 7a;

FIG. 7d is a cross-sectional view of the head nut of FIG. 7c along the line A-A:

FIG. 7e is a cross-sectional view of the head nut of FIG. 7c along the line B-B;

FIG. 7e is a side view of the head nut of FIG. 7a:

FIG. 8a is a side perspective view of an embodiment of a head nut which may form part of the coupling of FIG. 1;

FIG. 8b is a leading end perspective view of the head nut of FIG. 8a;

FIG. 8c is a trailing end view of the head nut of FIG. 8a;

FIG. 8d is a cross-sectional view of the head nut of FIG. 8c along the line A-A:

FIG. 8e is a side view of the head nut of FIG. 8a:

FIG. 9a is a side perspective view of an embodiment of a head nut which may form part of the coupling of FIG. 1:

FIG. 9b is a leading end perspective view of the head nut of FIG. 9a:

FIG. 9c is a trailing end view of the head nut of FIG. 9a:

FIG. 9d is a cross-sectional view of the head nut of FIG. 9c along the line D-D:

FIG. 9e is a side view of the head nut of FIG. 9a:

FIG. 10a is a side perspective view of an embodiment of a head nut which may form part of the coupling of FIG. 1:

FIG. 10b is a leading end perspective view of the head nut of FIG. 10a:

FIG. 10c is a trailing end view of the head nut of FIG. 10a:

FIG. 10d is a cross-sectional view of the head nut of FIG. 10c along the line D-D:

FIG. 10e is a side view of the head nut of FIG. 10a:

FIG. 11a is a side perspective view of an embodiment of a head nut which may form part of the coupling of FIG. 1:

FIG. 11b is a cross-sectional view through a centre line of the head nut of FIG. 11a:

FIG. 12a is a cross-sectional, in-line for assembly perspective view of an embodiment of a head nut and mill liner which may form part of the coupling of FIG. 1:

FIG. 12b is a cross-sectional perspective view of the embodiment of a head nut of FIG. 12a, which may form part of the coupling of FIG. 1:

FIG. 12c is a top cross-sectional view of an embodiment of a mill liner of FIG. 12a, which may form part of the coupling of FIG. 1:

FIG. 12d is a side cross-sectional, assembled view of an embodiment of a head nut and mill liner of FIG. 12a which may form part of the coupling of FIG. 1:

FIG. 13a is a perspective view of an embodiment of the head nut of FIG. 2a in a locating position being installed in the mill liner of FIG. 1;

FIG. 13b is a cross-sectional view of the head nut and mill liner of FIG. 13a:

FIG. 13c is a cross-sectional view of the head nut of FIG. 2a in a seated position being installed in the mill liner of FIG. 1:

FIG. 13d is an inner surface perspective of the head nut of FIG. 2a in the seated position installed in the mill liner of FIG. 1:

FIG. 14a is a wear surface perspective view of the mill liner of FIG. 1 mounted to a section of the grinding mill using the coupling of FIG. 1:

FIG. 14b is a wear surface plan view of the mill liner, grinding mill and coupling of FIG. 14a:

FIG. 14c is a side view of the mill liner, grinding mill and coupling of FIG. 14a:

FIG. 14d is a cross sectional view of the mill liner, grinding mill and coupling along the line A-A of FIG. 14b;

FIG. 15a is a wear surface cut away perspective view of the mill liner of FIG. 1 mounted to a section of the grinding mill using the coupling of FIG. 1:

FIG. 15b is a wear surface cut away plan view of the mill liner, grinding mill and coupling of FIG. 15a: and

FIG. 15c is a cut away side view of the mill liner, grinding mill and coupling of FIG. 15a.

### DETAILED DESCRIPTION

In the following detailed description, reference is made to accompanying drawings which form a part of the detailed description. The illustrative embodiments described in the detailed description, depicted in the drawings and defined in the claims, are not intended to be limiting. Other embodiments may be utilised and other changes may be made without departing from the spirit or scope of the subject matter presented. It will be readily understood that the aspects of the present disclosure, as generally described herein and illustrated in the drawings can be arranged, substituted, combined, separated and designed in a wide variety of different configurations, all of which are contemplated in this disclosure.

Grinding mill liners 10 are replaceable wear parts designed to suit different applications, such as SAG/AG, ball and rod mills. The mill liners 10 may be various shapes to suit the application and manufactured of cast materials (such as cast steel) or composite materials (such as fabricated metal, fabricated metal with a mixture of steel/iron and rubber, and rubber and metal (e.g., steel) to suit the application. Typically, grinding mills 14 are harsh environments which makes replacement of the worn mill liners 10 difficult and dangerous for operators. Couplings which may be secured and removed from outside the grinding mill mitigate the risks involved for the operators throughout the installation and replacement process.

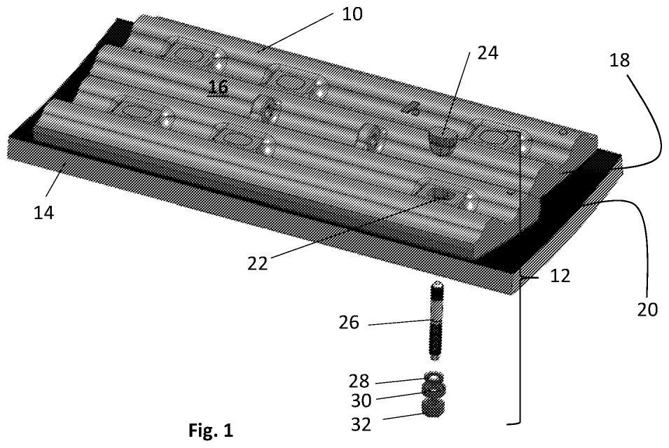

In general, FIG. 1 illustrates an embodiment of the mill liner 10 and a coupling 12. A portion of the grinding mill 14 is also shown for context. The mill liner 10 includes a wear surface 16 and an opposite inner surface 18. The mill liner 10 is removably mountable to an interior surface 20 of the grinding mill 14. The mill liner 10 includes at least one passage 22 having an interior wall formed in the mill liner 10 for receiving a part of the coupling 12. In the form shown, the passage extends from the wear surface 16 to the inner surface 18. In the illustrated embodiment, the mill liner 10 includes six passages 22. It is understood that any suitable number of passages may be included in the mill liner.

The coupling 12 includes a head nut 24, a shank 26, a washer 28, a recessed washer 30 and a hexagonal nut 32. The shank 26 may be a bolt shank or a stud shank, for example.

A head nut 24 is located in each passage 22. The head nut 24 is located in the passage 22 prior to the mill liner entering the grinding mill 14. In this way, the miller liner is provided as an assembly that incorporates the head nuts installed. As will be explained in more detail below, the head nuts include engaging portions that retain the head nuts in position for transport and installation. The retention may also allow the head nut to be more precisely retained in the passage to facilitate the connection of the shank 26 to the head nut. This may be through more accurate axial and/or angular positioning of the head nut in the passage.

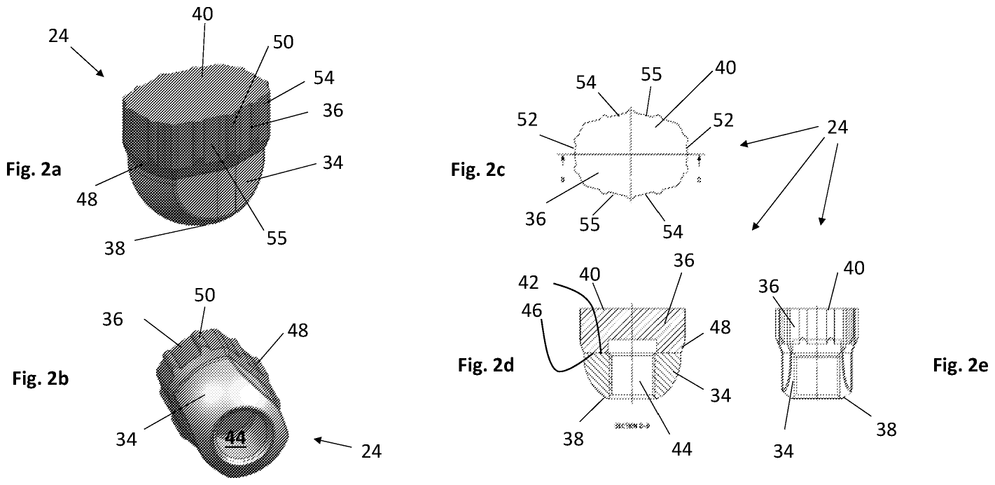

Illustrated in FIGS. 2a to 12d are ten embodiments of head nuts which will be described in detail below. Although, the first embodiment of the head nut 24 is shown in relation to the mill liner and grinding mill, any one of the embodiments of the head nuts described herein may be used to mount the mill liner to the grinding mill.

Referring first to FIGS. 2a to 2e, a first embodiment of the head nut 22 is illustrated. The head nut 24 includes a body 34 and an engaging portion 36, and extends between a leading end 38 and a trailing end 40. The body 34 of the head nut 24 extends between a leading end 38 and a connecting face 42. The body 24 includes an interior bore 44 that extends along an axis A. The interior bore 44 is operative to receive the shank 26. The interior bore 44 may include an internal thread for engaging a corresponding external thread on a shank of the shank 26. Other forms of engagement may be used, such as a bayonet fitting, or another kind of mechanical interlock fit.

The engaging portion 36 is connected to or integrally formed with the connecting face 42 of the body 34 to engage the interior wall of the passage 22. In the illustrated embodiment, the engaging portion 36 extends between the trailing end 40 and a connecting surface 46. The engaging portion 36 is formed of a deformable material including an elastomeric material such as rubber or a resilient material such as neoprene. The deformable engaging portion 36 engages the interior wall of the passage 22 by frictional engagement. It is understood that in alternative embodiments, the engaging portion may be formed of another material that is not considered deformable and thus would engaging the interior wall of the passage by mechanical interlock, snap fit or another engagement arrangement.

In some embodiments, the deformable engaging portion 36 may be connected to or integrally formed with the body 24. In some embodiments, a bonding member may be adhered to a connecting face of the body 24. The connecting face 42 of the body 24 may be adhered to a connecting surface of the engaging portion 36. The head nut 24 is placed in an autoclave to vulcanise deformable engaging portion 36 to the body 24. The deformable engaging portion 36 is vulcanised to the body 24 using a mould. Adhesion may also be used to connect the body and the engaging portion. In other arrangements where the engaging portion is integrally formed with the body, this may be achieved from a moulding, casting, extruding or printing process and may be formed from uniform material or from multiple materials.

The deformable engaging portion 36 projects in a radially relative to the body 24 to define a shoulder 48. The shoulder 48 extends about the external surface of the head nut, and extends from the connecting surface of the engaging portion 36. The shoulder 48 is raked and extends at an angle from the connecting surfaces towards the trailing end 40. It is understood that the shoulder may extend at any suitable angle provided the dimensions of the engaging portion 36 in the cross-sectional radial plane shown in FIG. 2c (i.e., the radial plane) are larger than the dimensions of the body 34 in a cross-sectional radial plane extending in the same direction perpendicular to the longitudinal axis of the bore 44.

The interior bore 44 extends from the leading end 38 into the body 34 and, in the illustrated embodiment, the interior bore 44 extending from the leading end 38 into the engaging portion 36 to form a blind interior bore (as shown in FIG. 2d) terminating at an end face. The shank 26 includes a lead in portion which does not include an external thread. In use, when the shank 26 is in threaded engagement with the head nut, the lead in portion of the shank 26 is accommodated by the portion of the interior bore that extends into the engaging portion 36. In alternative embodiments, the interior bore extends from the leading end to the trailing end, only extends into the body and not the engaging portion, and/or the engaging portion may also include an internal thread. Further alternatively, the engagement between the head nut and the shank may be any suitable mechanical arrangement such as a bayonet fitting, an adhesive, or any other suitable engagement arrangement.

The deformable engaging portion 36 includes external profiling formed on its external surface which protrudes in the radial direction. The external profiling increases the external surface irregularity to increase the frictional engagement. In the illustrated embodiment, the external profiling includes one or more ribs 50. The ribs 50 extend in the direction of the axis and are spaced apart about the external surface of the engaging portion 36. The ribs 50 extend from the shoulder 48 to the trailing end 40. The ribs 50 maintain the alignment of the interior bore relative to the opening of the passage for locating the shank in the interior bore via the opening of the passage. The ribs 50 also provide friction through increasing the external surface irregularity.

In the cross-sectional radial plane (as shown in the end view of FIG. 2c) the engaging portion 36 and body 34 are generally hexagonal shaped including radiused corners between each side. The nut may be any non-circular shape in the radial plane. In the plan view shown in FIG. 2c, the head nut includes four opposing sides walls (i.e., two sets of opposing side walls) having a first angle between each of the two opposing side walls 54 and the two opposing side walls 55. The respective side wall 54, 55 and the respective end wall 52 have a second angle between them. The first angle is larger than the second angle. Between each of the side walls 54, 55 and the end walls 52 are radiused transition regions (i.e., rounded corners). The side walls 54, 55 and the end walls 52 generally between the leading end 38 and the trailing end 40.

The leading end 38 includes a seating surface which allows the head nut to move relative to an opposed surface of the interior wall, for example, a complementary-shaped interior wall of the passage 22. The relative movement promotes self-centring of the head nut, and assists in locating the head nut in its seated position where the spherical surface 38 and the opposed surface of the interior wall of the passage abut one another. There may be a clearance between the seating surface and the opposed surface of the interior wall of the passage. It is understood that the seating surface and the opposed surface may not be identical in shape. In the illustrated embodiment, the seating surface is a spherical surface. In alternative embodiments, the seating surface may be other shapes that allow the nut to self-centre such as an oval head nut, or a v-shaped head nut.

The spherical surface 38 includes radiused transition surfaces between the leading end 38 and the end walls 52. As shown in FIG. 2d (cross-section along the line D-D in FIG. 2c), the end walls 52 of the body 34 extend from the connecting face 42 through the radiused transition region to the spherical surface of the leading end 38. As shown in FIG. 2e, the side walls 54, 55 also extend from the connecting face 42 through a smaller radiused transition region to the spherical surface 38. The side walls 54 extend closer to the leading end 38 than the side walls 52.

The side walls 54, 55 and the end walls 52 extend into the engaging portion 36. A central rib 50 is also positioned at the radiused transition region between the side wall 54 and the side wall 55. The central rib 50 extends in the axial direction and into the body to form a central ridge 56 in the body between the side wall 54 and the side wall 55. In the illustrated embodiment, each side wall 54 and each side wall 55 include one rib 50, and each end wall includes two ribs 50. The ribs 50 are equally spaced apart between the radiused transition regions (i.e., the corners) except for the central rib which extends along the respective radiused transition region.

During installation, torque is applied to the coupling 12 via the shank to threadingly engage the shank 26 and the head nut 24. The shank 26 includes a drive end which may include a drive head, e.g., the hex nut 32 as the drive head. The shank 26 also includes the external threading extending along the shank 26 which engages the interior threading of the head nut 24. The torque is applied to the drive end to rotate the shank 26. The non-circular shape of the head nut 24 in cross-sectional radial plane and the mating shape of the interior wall of the passage 22 prevents relative rotation of the head nut 24 in the passage upon rotation of the shank 26. As a result, the torque is translated to axial movement such that the head nut 24 translates axially along the length of the shank 26 on continued rotation of the shank 26. This can pull the nut 24 (overcoming the retention force provided by the engaging portion) to a seated position where the spherical surface abuts the interior wall of the passage, and/or tensions the coupling. When the coupling is tensioned, the mill liner is mounted to the interior surface of the mill. To remove the mill liner from the interior surface of the mill, the reverse operation is performed.

A single nut 24 may also be replaced without replacing the mill liner. One way to replace the nut is to remove the shank from the nut, and insert a tool into the interior bore of the nut 44 to push on the end face and push the nut into the grinding mill. The mill liner remains mounted to the grinding mill through the other couplings being tensioned. Another way is to leave the shank engaged with the nut and push the shank and nut through to the inside of the grinding mill. This removal process may also be performed when the mill liner is outside the grinding mill.

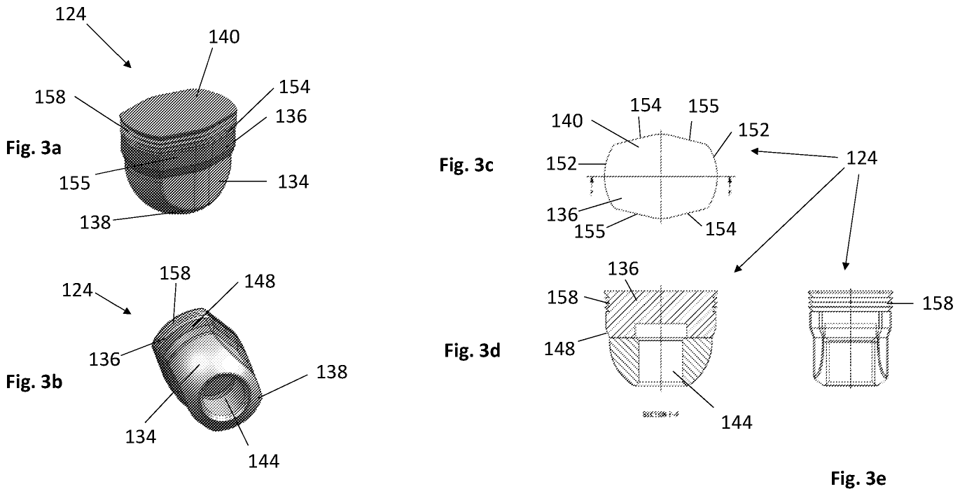

A second embodiment of a head nut 124 is shown in FIGS. 3a to 3e. The primary difference between the first embodiment of the head nut 24 and the second embodiment of the head nut 124 is the external profiling of the engaging portion 136. Like reference numerals are used for like features with the addition of the prefix “1”.

The external profiling includes one or more fins 158 extending in the radial direction. The fins 158 also extend about the external surface of the engaging portion 136 in the radial plane. It is understood that in alternative embodiments the fins are not required to continuously extend about the external surface and may be interrupted or spaced apart.

The fins 158 are positioned proximal or at the trailing end 140 and are spaced apart coaxially towards the connecting surface 146. In the illustrated embodiment, four fins are shown spaced between the trailing end 140 to about the centre of the side walls 152, 154 of the engaging portion 136. As shown in FIGS. 3d and 3e, the fins 158 have ramped surface or a triangular profile that are angled towards the trailing end 140. The angle of the fins 158 is such that the fins enable the nut 124 to be pushed into the passage easily, and more difficult to remove from the passage. The fins 158 maintain the alignment of the interior bore 144 relative to the opening of the passage 122 for locating the shank 26 in the interior bore 144 via the opening of the passage 122. The fins 158 also provide friction through increasing the external surface irregularity to retain the head nut 124 within the mill liner.

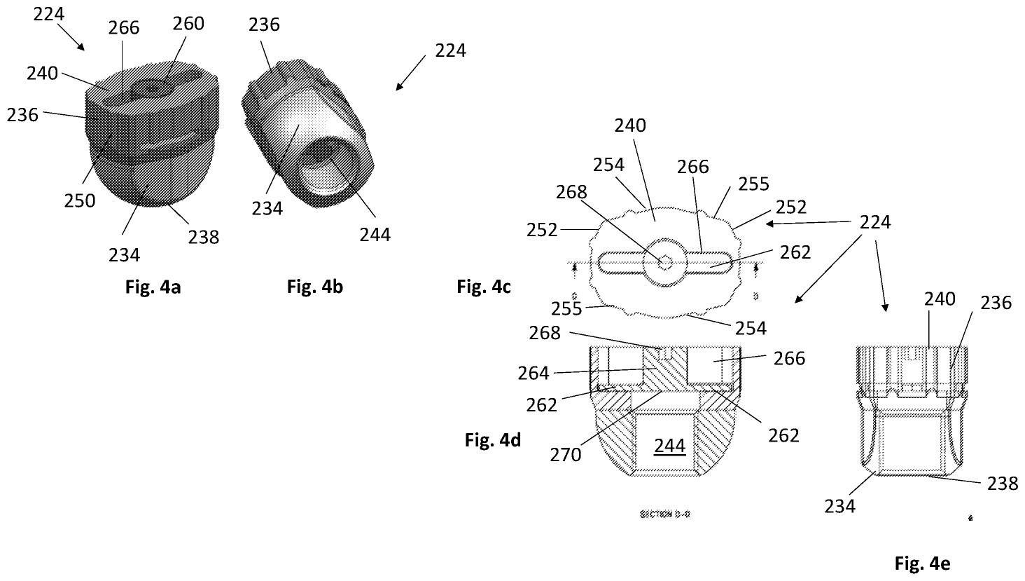

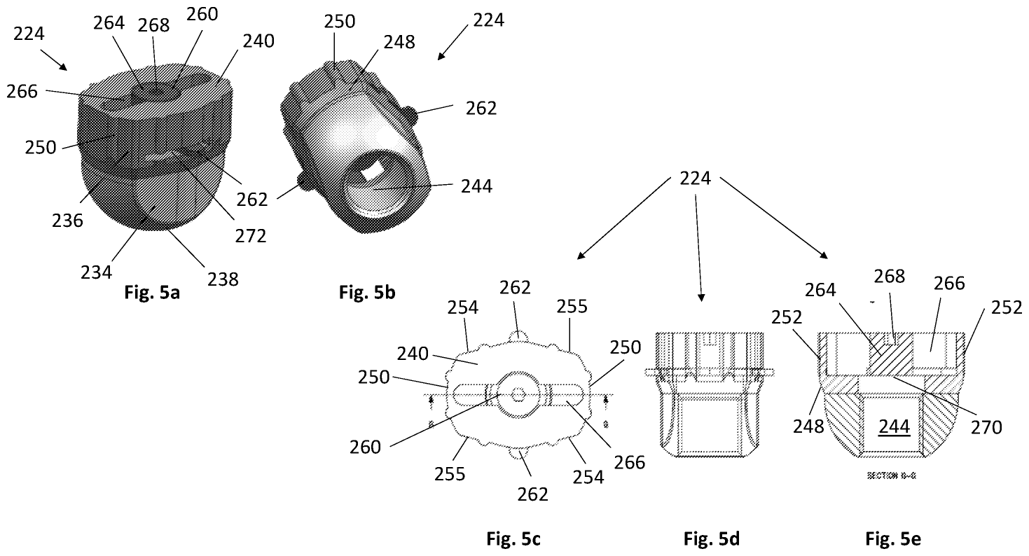

A third embodiment of a head nut 224 is shown in FIGS. 4a to 5e. Like reference numerals are used for like features with the addition of the prefix “2”. The third embodiment of the head nut 224 includes the ribs 250 as shown in the first embodiment of the head nut 24 as well as a locking arrangement 260. The ribs 250 maintain the alignment of the interior bore 244 relative to the opening of the passage 222 for locating the shank 26 in the interior bore 244 via the opening of the passage 222. The locking arrangement 260 prevents movement of the head nut 224 within the passage 222.

The locking arrangement 260 includes at least one locking member 262 and an actuator 264. A cavity 266 is defined in the engaging portion 236 for locating the locking arrangement 260 therein. The actuator 264 extends along the axis from the trailing end towards the connecting surface 246. The interior bore 244 which extends into the engaging portion 236 terminates at the actuator 264. The actuator extends between a drive end 268 and a support end 270. The drive end 268 is in line with the trailing end 240 of the engaging portion 236. In the illustrated embodiment, the drive end 269 includes an internal hex drive for engaging with a tool. The drive end 269 may also be used to engage with the tool to locate the nut in the passage. The support end 270 is located in the cavity 266 inside in the engaging portion 236. The support end 270 may also include an internal drive to be accessed by a tool via the interior bore 244 to move the locking arrangement 260 between the locked and unlocked positions from outside the mill if necessary.

One or more locking members 262 extend from the actuator 264 in the radial direction. In the illustrated embodiment, two opposing locking members 262 extend from the actuator 264.

The cavity 266 is defined by an inner surface of the engaging portion 236 to accommodate the locking arrangement 260 and the movement of the locking arrangement 260 in and between its positions. In the illustrated embodiment, the cavity 266 includes a cylindrical portion extending along the axis to accommodate the actuator 264 and two opposing elongate wings in the radial direction as shown in FIGS. 4c and 4d. In a transverse direction, the cavity 266 includes complementary slots for receiving the locking members 262. The slots 272 extend from the central cavity to the external surface of each side wall 254 of the engaging portion 236. Each slot 272 includes an abutment surface defined by the inner surface of the cavity which is arranged to abut against each locking member in a locked position.

The locking arrangement 260 is rotatable between an unlocked position and the locked position and an unlocked position. The unlocked position is shown in FIGS. 4a to 4e, and the locked position is shown in FIGS. 5a to 5e. In the unlocked position, the locking arrangement 260 is locatable into the cavity in the axial direction from the trailing end 240. The shape of the cavity is a complementary shape to the actuator and the locking members. The locking members 262 are located internal the engaging portion 236. In the locked position, the actuator is rotatable via the drive end 268 to move the locking members 262 through an angular displacement through the respective slots 272 such that they project from each slot 272 and from the external surface of the engaging portion 236. In the locked position, the interior wall of the passage 222 defines complementary abutment surface(s) for abutting the locking members 262 and preventing axial movement (i.e., removal) of the head nut 224 relative to the mill liner 10. The complementary abutment surface(s) may be defined in respective corresponding recesses in the passage interior wall.

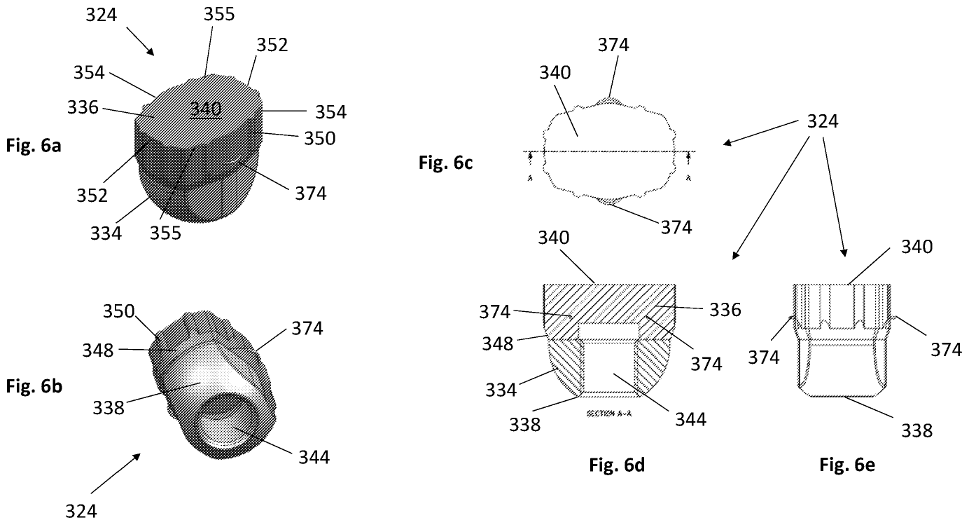

A fourth embodiment is illustrated of a head nut 324 is shown in FIGS. 6a to 6e. Like reference numerals are used for like features with the addition of the prefix “3”. The fourth embodiment of the head nut 324 is similar to the first embodiment of the head nut 24 in that the engaging portion 336 includes the ribs 350. The primary difference between the head nut 24 and the head nut 324 is that the head nut 324 further includes an engagement structure 374. The ribs 350 maintain the alignment of the interior bore 344 relative to the opening of the passage 322 for locating the shank 26 in the interior bore 344 via the opening of the passage 322. The engagement structure 374 prevents movement of the head nut 324 within the passage 322.

The engagement structure 374 protrudes radially from the external surface of the head nut 324 to engage an abutment surface located in a complementary recess defined by the interior wall of the passage 322, which retains the head nut 324 in the passage of the mill liner 10. In the illustrated embodiment, the head nut 324 includes opposing engagement structures 374 protruding from the central ridge 356 in each side wall 354. Each engagement structure 374 is embedded in the engagement portion 336. In use, the engagement structure 374 is able to resiliently deform to locate the head nut 324 in its seated position within the passage 322 such that the engagement structures 374 locate in the complementary recesses. Each engagement structure 374 may be in the form of a metal wire, leaf spring or any other suitable material which is able to resiliently deform.

The head nut 324 includes two ribs 350 extending along each end wall 352, and one rib in each side wall 354, 355. The ribs 350 in the side walls 354 are spaced apart from the central ridge 356 and the engaging structure 372 and the radiused transition regions. The ribs 350 in the side walls 352 are spaced apart between the radiused transition regions (i.e., the corners).

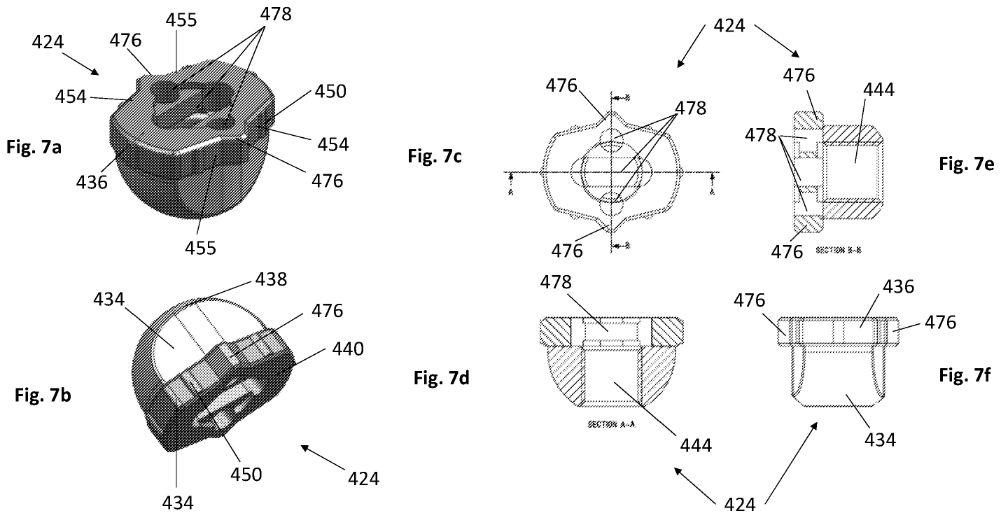

A fifth embodiment is illustrated of a head nut 424 is shown in FIGS. 7a to 7f. The fifth embodiment of the head nut 424 is similar to the first embodiment of the head nut 24 and the fourth embodiment of the head nut 324 in that the engaging portion 436 includes the ribs 450. Like reference numerals are used for like features with the addition of the prefix “4”. The primary difference between the head nut 324 and the head nut 424 is that the head nut 424 further includes an elongate tab 476. The ribs 450 maintain the alignment of the interior bore 444 relative to the opening of the passage 422 for locating the shank 26 in the interior bore 444 via the opening of the passage 422. The elongate tab 476 prevents movement of the head nut 424 within the passage 422.

The elongate tab 476 extends between the leading and trailing ends 438, 440 along the central ridge 456 to retain the head nut 424 within the passage 422 of the mill liner 10. The elongate tab 476 extends along both the engaging portion 436 and the body 434. In the illustrated embodiment, the head nut 424 includes opposing elongate tabs 476 extending along each side wall 454. The elongate tabs 476 are arranged to engage respective abutment surfaces defined in corresponding recesses of the interior wall of the passage 422. The elongate tabs 476 of the engaging portion 436 are arranged to resiliently deform such that, when the head nut 424 is being located in the passage 422 of the mill liner, the elongate tabs 476 resiliently deform against the interior wall of the passage 422 and are biased to resume their original shape once engaged into the corresponding recesses against the abutment surfaces. In this position (i.e., the seated position), the head nut 424 is preventing from movement relative to the passage. In the illustrated embodiment, the elongate tabs 476 of the engaging portion 436 are formed from an elastomeric material such as rubber. However, it is understood that any suitable flexible material may be used.

The engaging portion 436 also includes one or more reliefs 478 defined proximal to each elongate tab 476 to facilitate the resilient deformation of the tabs 476. The reliefs 478 are arranged to create an area of weakness which allows the tabs to preferentially deform when the abutment force of the interior wall of the passage is pressing the tabs 476 in a radial direction towards one another during installation of the head nut 424 in the liner 10. Adjacent each relief 478 is a support 480 which allows a tool to be inserted in the reliefs against each support 480. In some embodiments, a tool may be used to clamp the nut 424 and pull the tabs 476 inwards to facilitate installation of the nut 424 in the passage.

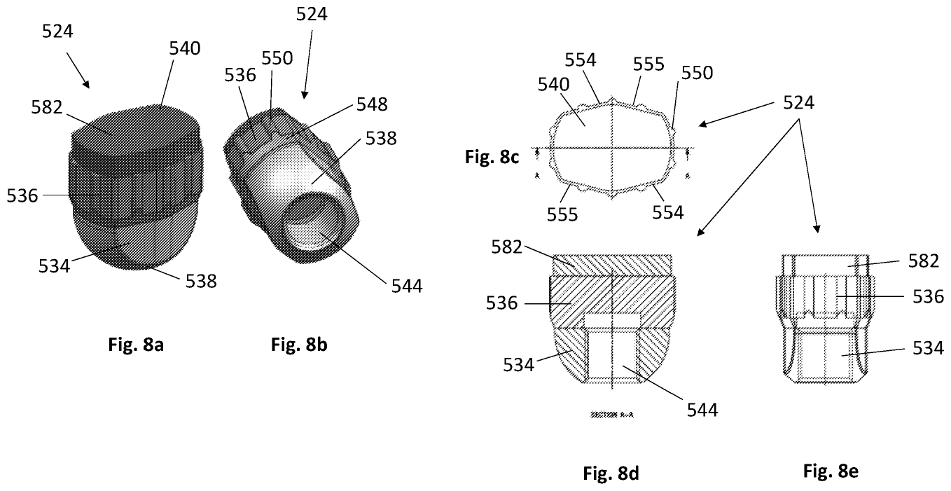

A sixth embodiment is illustrated of a head nut 524 is shown in FIGS. 8a to 8e. The fifth embodiment of the head nut 524 is similar to the first embodiment of the head nut 524 in that the engaging portion 536 includes the ribs 550. Like reference numerals are used for like features with the addition of the prefix “5”. The primary difference between the head nut 524 and the head nut 524 is that the head nut 524 further includes a wear resistant portion 582. The wear resistant portion 582 is connected to or integrally formed with the engaging portion 536 and the body 534. The head nut 524 including the wear resistant portion 582 prevents the wear resistant portion from becoming loose and potentially a safety hazard when an operator enters a grinding mill. The wear resistant portion 582 could be a casting, weld overlay, ceramic or other similar material which is connected to or integrally formed with the engaging portion 536 and the body 534 by the methods discussed herein.

In the illustrated embodiment, the wear resistant portion 582 forms the trailing end 540 of the head nut 524. Fines and other materials inside the mill getting trapped in the passage from the wear surface of the mill liner 10 can increase the wear on the mill liner 10 and the head nut, particularly of the surfaces surrounding the passages. Having the wear resistant portion 536 at the trailing end 540 of the head nut 524 can extend the useful life of the head nut 524 and the mill liner 10 and reduce the frequency of replacement due to wear.

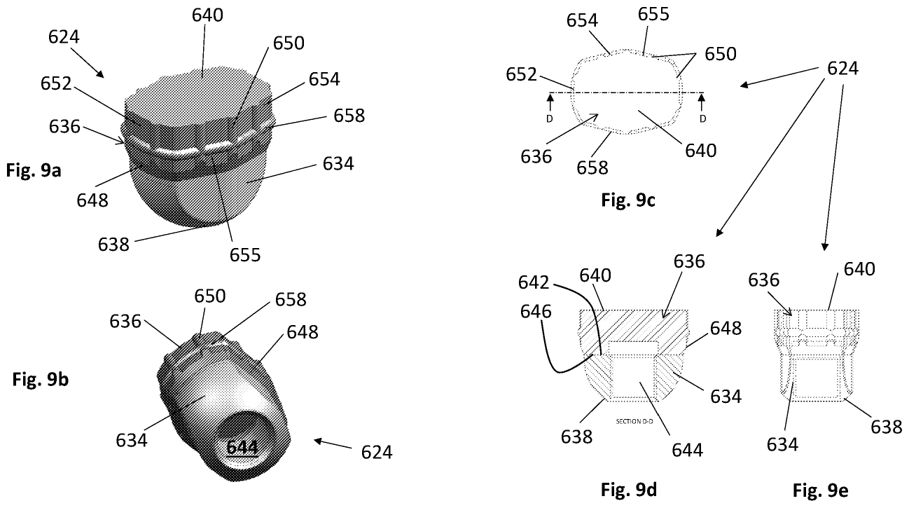

A seventh embodiment of a head nut 624 is shown in FIGS. 9a to 9e. The primary difference between the first embodiment of the head nut 24 and the seventh embodiment of the head nut 624 is the external profiling of the engaging portion 636. Like reference numerals are used for like features with the addition of the prefix “6”.

The external profiling in the seventh embodiment includes a radial rib 658 extending in the radial direction. In the form shown, a single radial rib 658 extends around the external surface of the engaging portion 636 in the radial plane. It is envisaged that, in alternative embodiments, more than one radial rib 658 may extend about the external surface, whereby each additional radial rib, i.e. more than one, can be spaced apart coaxially and generally parallel.

In the illustrated embodiment, the radial rib 658 is spaced from the trailing end 640 to about the centre of the side walls 652, 654 of the engaging portion 636. In some alternative forms, the radial rib 658 can be positioned closer to either of the trailing end 640 or the shoulder 648.

The radial rib 658 is configured to form a seal between the engaging portion 636 and the passage 622 to prevent water/slurry from entering the passage 622 where the head nut 624 locates in-use. Additionally, the radial rib 658 can contribute to the friction of the ribs 650 through increasing the external surface irregularity to retain the head nut 624 within the mill liner.

It is anticipated that the radial rib 658 of the seventh embodiment can be applied to any of the embodiments of the head nut set forth previously.

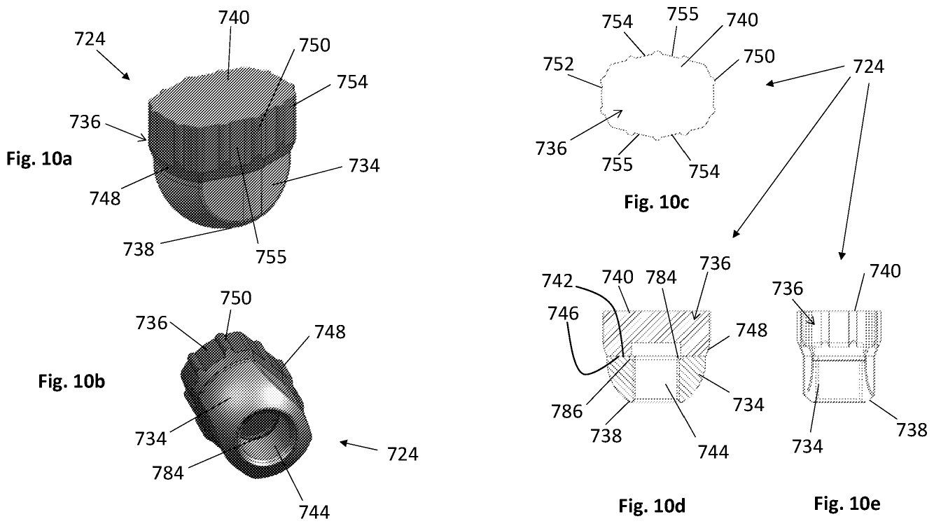

An eighth embodiment of a head nut 724 is shown in FIGS. 10a to 10e. The primary difference between the first embodiment of the head nut 24 and the eighth embodiment of the head nut 724 is the addition of a deformable material arranged radially about the internal thread of the interior bore 744. Like reference numerals are used for like features with the addition of the prefix “7”.

In the illustrated embodiment, the deformable material takes the form of a locking member 784 and is located proximal to the connecting surface 746 of the engaging portion 736. The deformable material can be received in a radial recess 786 formed in the bore 744 of the body 734, at the connecting surface 746.

The locking member 784 acts to engage, e.g. releasably bind or grip, with the corresponding external thread of the shank 26 when threadedly engaged thereto. In this way, the deformable material prevents, i.e. resists, loosening of the shank 26 from its threaded engagement.

The locking member 784 may be diametrically sized with respect to the thread of the bore 744 so as to extend into the in-use threaded path of the shank 726. When the external thread of the shank is threaded past, i.e. through the locking member 784, the deformable material of the member 784 is deformed, or cut into, by the external thread of the shank 26.

The locking member can be formed of a resilient material such as polyamide, e.g. nylon. Advantageously, the resilient material of the locking member can engage, i.e. grip against, the external thread of the shank 26 by frictional engagement to securely retain the shank and head nut 724 together. The torque required to tighten and loosen the shank with respect to the head nut is sufficiently high prevent loosening by e.g. vibration caused by the harsh operational environment of an in-use grinding mill.

In the form shown, locking member is positioned with respect to the connecting surface 746 such that when the threaded shank 26 is threaded into the locking member, the locking member is proximal to the lead in portion of the shank 26. It should be appreciated that in some alternative forms, the locking member 784 can be positioned further away from the connecting surface 746, i.e. closer to the leading end 738 of the nut 724.

The locking member 784 can be formed as an insert for mounting into the recess 786 of the body 734. The locking member can be press fit into the recess prior to forming the engaging portion 736 about the body 734. In this form, the locking member can be separate to the engaging portion 736. In some alternative forms, the locking member and the engaging portion 736 may be formed as a single body, i.e. the locking member may be moulded in a single process together with the engaging portion 736. In this form, the deformable portion is continuous with the engaging portion and hence, both the engaging portion and the locking member would be formed of the same material.

It is anticipated that the locking member 784 of the eighth embodiment can be applied to any of the embodiments of the head nut set forth previously.

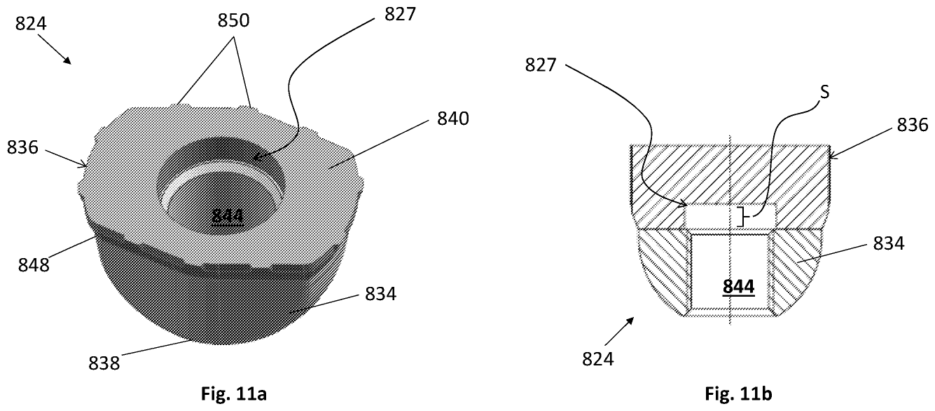

A ninth embodiment of a head nut 824 is shown in FIGS. 11a and 11b. The primary difference between the first embodiment of the head nut 24 and the ninth embodiment of the head nut 824 is the configuration of the engaging portion 836 as a wear indicator. Like reference numerals are used for like features with the addition of the prefix “8”.

In this embodiment, the bore 844 can be configured to extend into the engaging portion 836 such that a closed end 827 (i.e. a blind cavity) of the bore 844 is spaced at a predetermined distance ‘S’ from the connecting face 842. The depth of the blind cavity 827, i.e. the distance at which the closed end is spaced from the trailing end 840, is selected so that the bore 844 becomes visible once the liner (and trailing end) has been worn down during operation of the grinding mill. Advantageously, this arrangement provides a practical wear indicator notifying operators when the mill liner needs to be replaced.

It is anticipated that use of the blind cavity 827 as a wear indicator can be applied to any of the embodiments of the head nut set forth previously.

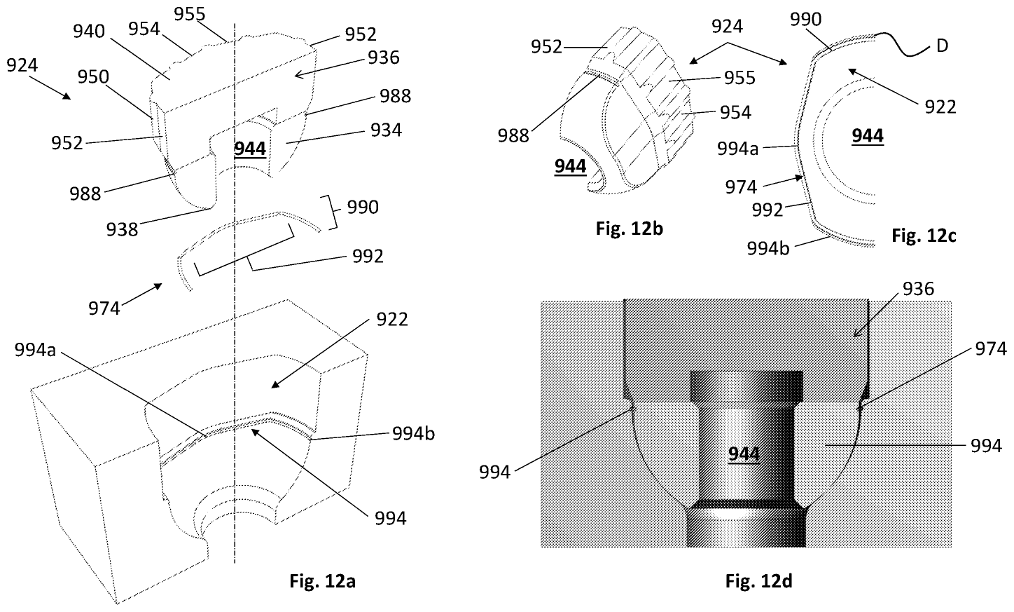

A tenth embodiment of a head nut 924 is shown in FIGS. 12a to 12d. The tenth embodiment of the head nut 924 is similar to the first embodiment of the head nut 24 in that the engaging portion 936 includes the ribs 950. The primary difference between the head nut 24 and the head nut 924 is that the head nut 924 is configured to receive an engagement structure 974 for resiliently retaining the head nut in the passage 922 of the mill liner. The engagement structure 974 is configured together with the head nut and passage to resiliently retain the head nut 924 in the seated position within the passage 922. Like reference numerals are used for like features with the addition of the prefix “9”.

The engagement structure takes the form of a spring clip 974 configured to resiliently mount in a complementary circumferential groove 994 defined in the interior wall (i.e. interior surface) of the passage 922. In the form best shown in FIG. 12c, the spring clip 974 is shaped and sized with respect to the circumferential groove 994 such that elongate sides 992 of the clip resiliently mount, i.e. nest, within two opposing side grooves 994a of the circumferential groove 994. The ends 990 of the clip are spaced by a distance ‘D’ from the interior walls of the passage 922 such that, in-use, the ends 990 protrude into a path of the head nut. That is, when the head nut 924 is inserted into the passage 922, the body 934 of the head nut contacts the ends 990 of the clip 974 to resiliently deform the clip so as to move the ends 990 through the distance ‘D’ (into opposing end grooves 994b of the interior wall). As the body 934 moves further into the passage 922, the ends 990 of the clip locate, i.e. snap-engage with abutment surfaces 988 formed on opposing end walls 952 of the body 934. In the form shown in FIGS. 12a to 12d, the abutment surfaces take the form of grooves 988 in the opposing ends of the body 934.

In this way, the spring clip resiliently retains, i.e. axially retains, the head nut 924 in the seated position within the passage 922.

The spring clip 974 may be in the form of a metal wire, leaf spring or any other suitable material which is able to resiliently deform. The complementary circumferential groove 994 and abutment surfaces 988 can be shaped and sized, i.e. in profile, to complement (e.g. nest) the spring clip 974.

In alternative forms of the spring clip arrangement, it is envisaged that the spring clip could alternatively be resiliently mounted to the head nut 924. In this form, the head nut 924 and spring clip 974, together, can be inserted into the passage for seating the head nut in a resiliently engaged position.

It is anticipated that the engagement structure, i.e. the spring clip 974, of the eighth embodiment can be applied to any of the embodiments of the head nut set forth previously.

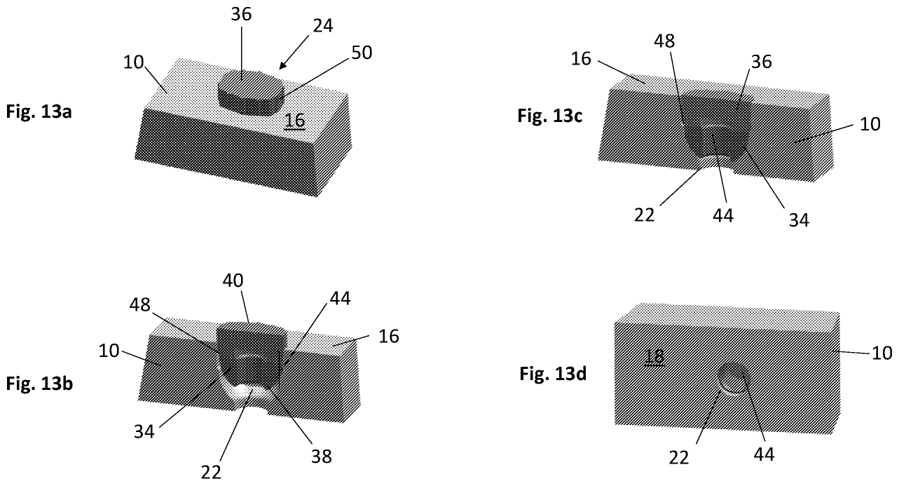

Now referring to FIGS. 13a to 13d, a method of installation of the first embodiment of the head nut 24 within the passage 22 of the mill liner 10 is disclosed.

Referring to FIGS. 13a and 13b, the method includes the step of providing the head nut 24 comprising the body 34 and the engaging portion 36 discussed in detail above. In the illustrated embodiment, the engaging portion 36 is deformable but it is understood that solely a mechanical engagement may be used, such as the locking arrangement disclosed above combined with the engaging portion.

The method further includes the step of locating the leading end 38 in the passage 22 such that the body 34 is held in a locating position by the deformable engaging portion 36. The deformable engaging portion 36 engages the interior wall of the passage 22 such that the leading end 38 is spaced apart from the opening of the passage 22. The head nut 24 is able to be guided into position by the deformable engaging portion 36 retaining the body 34 of the interior bore 44 of the head nut in alignment relative to the opening of the passage through the installation process. The body 34 is held in the locating position through engagement of the external surface of the engaging portion including the fins with the corresponding shoulder of the interior wall of the passage.

Referring to FIGS. 13c and 13d, the method includes the step of applying force to the head nut 24 to move the head nut 24 to a seated position where the leading end 38 abuts the interior wall of the passage, and the interior wall is aligned with the opening of the passage. In the illustrated embodiment, the method includes the step of applying the force to the trailing end 40 of the head nut 24 formed on the deformable engaging portion 36 to move the head nut 24 to the seated position. The force may be applied to the trailing end 40 by a hammer or any other suitable tool which assists to apply force. The force may also be applied to the body to move the head nut to the seated position. Further, the shank 26 may be threadingly engaged with the interior bore 44 of the head nut 24. Upon rotation of the shank 26 (applying a torque force to the head nut 24), the head nut 24 moves in the axial direction along the shank 26 to either move the head nut to the seated position and/or to tension the coupling 12 and mount the mill liner 10 to the inner surface 18 of the grinding mill.

The head nut may be preinstalled in the mill liner prior to the mill liner entering the grinding mill. The mill liner may also be shipped with the head nut preinstalled in the mill liner. Also disclosed is a method of shipping, storage, installation and/or use of the mill liner. The method comprises the steps:
providing the mill liner having the at least one passage being defined by the interior wall;
providing the head nut comprising the body having the interior bore extending along the axis operative to receive the shank, and the engaging portion being connected to or integrally formed with the body: and
locating the head nut to seated located position where the head nut abuts the interior wall of the passage so as to retain the head nut within the passage for shipping, storage, installation and/or use of the mill liner.

The method may further include providing a lubricant, such as grease, in the interior bore to facilitate the coupling engagement.

The head nut resists axial movement in both directions (i.e., inward and outward of the passage) to better resist unintentional loss of the head nut during shipping, storage, installation and use. In some forms, the head nut is frictionally retained in the passage of the mill liner. In some forms, the head nut is mechanically retained in the passage of the mill liner.

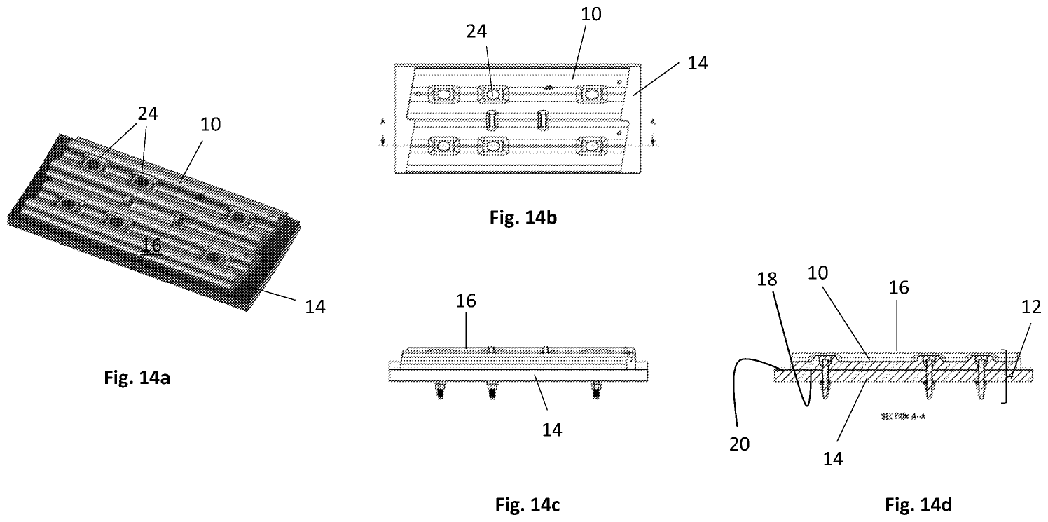

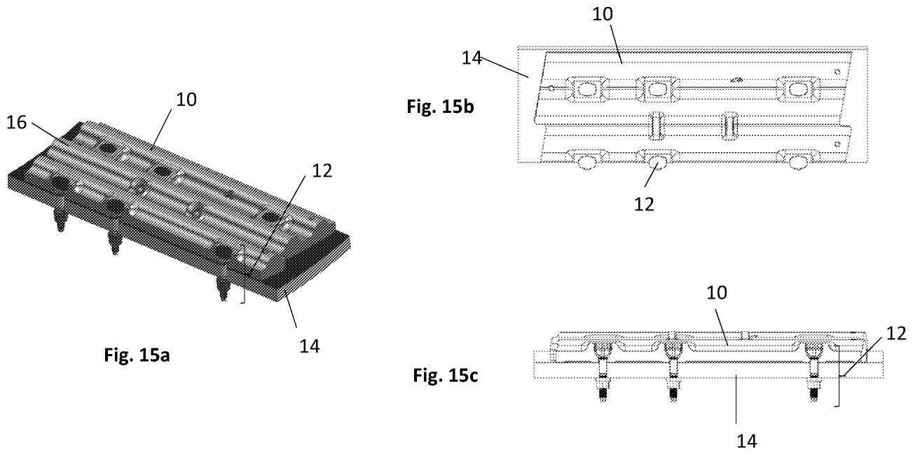

Illustrated in FIGS. 14a to 15c is a cut away section of the grinding mill showing the coupling in an assembled condition mounting the mill liner to the inner surface of the grinding mill. The mill liner may be assembled as a wear part kit including the mill liner 10 and one or more couplings 12. The coupling 12 including the head nut, the shank 26 (e.g., a bolt or a stud), the rubber sealing washer 28, the recessed washer 30 and the hex nut 32.

Prior art head nut and shank arrangements generally require access to both sides of the assembly that is being secured. The main disadvantage is that access must be available to both sides of the liner to install or remove the shank. However, in certain applications and circumstances, access to the mill may be prevented for a number of reasons, from simple physical restraints and size restrictions to safety regulations. This disclosure provides a coupling that requires only access to the external side of the grinding mill to fasten and tension the coupling. This eliminates the need for people inside the grinding mill inserting fastening arrangements in the mill liners, and provides a safe, effective, reliable coupling arrangement for removably mounting the mill liners to the inner surface of the grinding mill. Installation times of the head nut are improved by implementing the head nut as disclosed herein.

The embodiments of the head nut disclosed herein have at least the following advantages:
The deformable engaging portion provides frictional resistance to allow engagement of the shank and the head nut. The head nut won't push out of alignment.
The deformable engaging portion provides alignment (i.e., a guided effect) for locating the shank into the interior bore of the body of the head nut. The deformable engaging portion retains the axis of the interior bore in the same line as the shank of the shank and prevents the head nut from moving axially in the passage.
The head nut prevents ball entrapment. The steel balls from within the mill are prevented from getting trapped in the passage. A protective cap may also be provided if the trailing end of the head nut is not flush with the wear surface of the mill liner. Alternatively, the head nut may be proud of the wear surface.
The head nut may be manufactured in all-purpose sizes for different length passages, e.g., the passage extending through the lifter versus the plate.
The engaging portion being connected to or integrally formed with the body prevents the engaging portion from coming away from the body of the head nut.
The engaging portion may include a drive end to be engaged with a tool to install the head nut in the mill liner.
Removal of the head nut from the mill liner is easier and safer because they are connected together or integrally formed. The mill liner can be knocked into the grinding mill from outside the mill and the head nut can be retained in the mill liner.
The coupling provides a flexible arrangement to allow easy replacement of damaged parts, such as the mill liner or any component of the coupling.

Variations and modifications may be made to the parts previously described without departing from the spirit or ambit of the disclosure.

For example, the length of the head nut in the axial direction may vary to suit different applications of mill liners and grinding mills having different length passages or to accommodate other components in the passage such as a cap or an additional engaging portion.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1-38. (canceled)

39. A mill liner assembly for a grinding mill comprising a mill liner having a wear surface and an opposite inner surface, and a head nut forming part of a coupling for use in removably mounting the mill liner to an interior surface of the grinding mill, the mill liner further comprises at least one passage having an interior wall extending in the liner for receiving the head nut,
wherein the head nut comprises a leading end and a trailing end being spaced apart along an axis:
a body having an interior bore extending along the axis operative to receive a shank, the shank forming part of the coupling; and
an engaging portion connected to or integrally formed with the body to engage the interior wall of the passage to retain the head nut in the at least one passage in the mill liner.

40. A mill liner assembly according to claim 39, wherein the engaging portion is formed of a deformable material that is arranged to deform when the heat nut is disposed within the passage to retain the head nut within the at least one passage.

41. A mill liner assembly according to claim 39, wherein the engaging portion is operative to align the bore of the head nut relative to the at least one passage for locating the shank therein, and the engaging portion extends in the direction of the axis from the body to the trailing end.

42. A mill liner assembly according to claim 39, wherein the body includes a seating surface forming the leading end and allowing the head nut to move relative to an opposed seat formed in the interior wall of the at least one passage to self-centre and align the interior bore of the body relative to an opening of the passage for receipt of the shank in use.

43. A mill liner assembly according to claim 39, wherein the engaging portion comprises a radial extension defining a shoulder that extends at least a portion of the external surface of the head nut, and, the interior wall of the mill liner comprises a corresponding shoulder and wherein in use, the shoulder is arranged to engage a corresponding shoulder defined in the interior wall of the passage.

44. A mill liner assembly according to claim 39, wherein the engaging portion includes external profiling formed on its external surface protruding in the radial direction from the external surface of the body.

45. A mill liner assembly according to claim 44, wherein the external profiling includes one or more ribs extending in the direction of the axis of the at least one passage.

46. A mill liner assembly according to claim 39, wherein the passage includes a locking member for releasably retaining the shank therein.

47. A head nut when used for a mill liner, the head nut forming part of a coupling for use in removably mounting the mill liner to an interior surface of the grinding mill, the mill liner including at least one passage having an interior wall formed in the liner for receiving the head nut, the head nut comprising a leading and a trailing end being spaced apart along an axis and further comprising:
a body comprising an external surface, the body having an interior bore extending through the body along the axis operative to receive a shank, the shank forming part of the coupling; and
an engaging portion connected to or integrally formed with the body to engage the interior wall of the passage.

48. A head nut according to claim 47, wherein the engaging portion is formed of a deformable material which is arranged to retain the head nut within the least one passage when in a deformed state.

49. A head nut according to claim 47, wherein the engaging portion extends radially from the body to define a shoulder which extends about at least a portion of the external surface of the head nut.

50. A head nut according to claim 47, wherein the engaging portion includes external profiling formed on its external surface protruding in the radial direction about the head nut.

51. A head nut according to claim 50, wherein the external profiling includes one or more ribs extending in the direction of the axis.

52. A head nut according to claim 47, wherein the passage includes a locking member for releasably retaining the shank therein.

53. A head nut according to claim 47, wherein the body includes a seating surface forming the leading end and allowing the head nut to move relative to the complementary interior wall of the at least one passage to self-centre and align the interior bore of the body relative to an opening of the passage for receipt of the shank in use.

54. A head nut according to claim 47, wherein the engaging portion comprises a locking arrangement including at least one locking member movable between a locked position and an unlocked position, wherein, when in the locked position, the at least one locking member protrudes in the radial direction from the external surface of the head nut to engage an abutment surface formed in the interior wall of the passage to retain the head nut in the passage, and when in the unlocked position, the at least one locking member locates radially inwardly to disengage the abutment surface.

55. A head nut according to claim 54, wherein the at least one locking member is rotatable between the locked and unlocked positions, and the head nut includes at least one slot extending in the radial direction to the external surface for accommodating the at least one locking member.

56. A head nut according to claim 55, wherein the locking arrangement includes an actuator extending along the axis, the locking member extends radially from the actuator, and the actuator is rotatable about the axis to move the locking member between the locked and unlocked positions.

57. A method of installation of a head nut within a passage of a mill liner, the passage being defined by an interior wall and extending to an opening in the mill liner, the head nut forming part of a coupling for use in removably mounting the liner to an interior surface of a grinding mill,
the method comprising:
providing a head nut comprising a body having an interior bore extending along an axis operative to receive a shank, the shank forming part of the coupling;
locating a leading end of the body in the passage such that the body is held in a locating position such that the leading end is spaced apart from the opening of the passage;
applying force to the head nut to move the head nut to a seated position where the leading end abuts the interior wall of the passage, and the interior bore is aligned with the opening of the passage.

58. A method according to claim 57, further comprising applying force to the trailing end of the head nut to move the head nut to the seated position.
